(19) United States
(12) Patent Application Publication
(10) Pub. No.: US 2002/0034460 A1
(43) Pub. Date: Mar. 21, 2002

(54) Catalytic converter body with reduced wall thickness on an inflow side and process for producing a catalytic converter body

(76) Inventors: Rolf Bruck, Bergisch Gladbach (DE); Jorg-Roman Konieczny, Siegburg (DE)

Correspondence Address: LERNER AND GREENBERG, P.A., Post Office Box 2480, Hollywood, FL, 33022-2480, US

(21) Appl. No.: 09/962,693

(22) Filed: Sep. 24, 2001

Related U.S. Application Data
(63) Continuation of application No. PCT/EP00/01198, filed on Feb. 14, 2000.

(30) Foreign Application Priority Data
Mar. 22, 1999 (DE) 199 12 846.4

(51) Int. Cl. B23D 15/00; B01D 53/88; B01D 53/92

(52) U.S. Cl. 422/180; 422/177; 29/890

(57) ABSTRACT

A catalytic converter body includes at least one honeycomb body, in particular with a catalytically active coating, having a multiplicity of axial passages through which a fluid can flow. The passages have passage walls ending in a common plane perpendicular to a flow direction. The passage walls each have average wall thicknesses and starting sections with reduced wall thicknesses, at least in the vicinity of the end surface. A process for producing a catalytic converter body includes forming at least one honeycomb body with a catalytically active coating and a multiplicity of axial passages through which a fluid can flow. The passages have walls delimited in a common plane perpendicular to a flow direction. Each of the walls has an average wall thickness and starting sections with reduced wall thicknesses at least in the vicinity of an end surface.

### CROSS-REFERENCE TO RELATED APPLICATION

This application is a continuation of copending International Application No. PCT/EP00/01198, filed Feb. 14, 2000, which designated the United States.

### BACKGROUND OF THE INVENTION

### FIELD OF THE INVENTION

The invention relates to a catalytic converter body, in particular for use in the exhaust system of a motor vehicle which is driven by an internal combustion engine. The invention also relates to a process for producing a catalytic converter body.

A plurality of processes are known in the prior art for reducing the levels of pollutant emissions from an internal combustion engine. A distinction has to be drawn between two different types of pollutant, namely gaseous pollutants and particles, in particular soot particles. In the case of diesel vehicles, the soot particles have long been regarded as the most harmful component, and for that reason numerous devices have been developed for removing those soot particles from the exhaust gas. For example, U.S. Pat. No. 4,404,795 has disclosed a filter body which is gas-permeable but retains soot particles. In order to prevent that filter from becoming blocked by an excessive accumulation of soot particles, the filter body is heated from time to time by an electrical heater in its front region to such an extent that the accumulated layer of soot ignites and burns off. In order to assist that operation, additional air may be fed-in in that state upstream of the filter body.

A further concept for lowering the levels of pollutants in diesel engines works on the basis of having to oxidize the hydrocarbons and carbon monoxide contained in the diesel exhaust gas, in order to eliminate that fraction of pollutants. For that purpose, similar oxidation catalytic converters are used in diesel engines to those found in spark-ignition engines, namely honeycomb bodies with a large number of passages which are permeable to the exhaust gas and have a catalytically active coating that promotes the oxidation of hydrocarbons and carbon monoxide. However, that leads to a problem which is that in oxidation catalytic converters of that type, which in principle are not constructed as filters, but rather have clear passages, a layer of soot is deposited relatively quickly on their surface. That layer blocks the pores and therefore reduces the size of the catalytically active surface or even covers it altogether. Consequently, in practice, an oxidation catalytic converter with a layer of soot of that type can no longer provide any catalytic activity. In oxidation catalytic converters of that type, the soot accumulates in particular from the area of the end surfaces of the catalytic converter body. Consequently, there is a particularly substantial formation of the layer of soot in the front region of the walls of the honeycomb body, which is particularly undesirable since that is where the temperature required for catalytic conversion is reached most quickly after the internal combustion engine has been started. Therefore, a reduction in the catalytic activity in that region leads to an increase in the emission of pollutants during the cold-start phase.

### SUMMARY OF THE INVENTION

It is accordingly an object of the invention to provide a catalytic converter body with reduced wall thickness on an inflow side and a process for producing a catalytic converter body, in particular for use in an exhaust system of an internal combustion engine, preferably a diesel engine, which overcome the hereinafore-mentioned disadvantages of the heretofore-known devices and processes of this general type and which easily and inexpensively counteract an accumulation of particles in the vicinity of an end surface of the catalytic converter body.

With the foregoing and other objects in view there is provided, in accordance with the invention, a catalytic converter body, comprising at least one honeycomb body, in particular with a catalytically active coating, having an end surface and a multiplicity of axial passages through which a fluid can flow in a flow direction. The passages have respective passage walls ending substantially in a common plane perpendicular to the flow direction. The passage walls each have substantially average wall thicknesses and starting sections with reduced wall thicknesses as compared to the average wall thicknesses, at least in the vicinity of the end surface.

The axial extent of the honeycomb body, as well as its cross-sectional shape, is matched to the particular installation conditions in the vehicle. The length usually lies in the region of several centimeters and a substantially circular cross-sectional shape is usually provided. However, other lengths and other cross-sectional shapes are also possible in principle. The coating preferably includes a washcoat which preferably is formed of porous aluminum oxide (Al₂O₃) containing, for example, platinum (Pt) and/or rhodium (Rh) as catalytically active material. The wall thickness of the catalytic converter body results from the respective wall thickness of the walls of the actual honeycomb body and the thickness of the coating. The coating is preferably applied to both sides of the walls. The walls define the axial passages through which a fluid can flow and which extend through the catalytic converter body between the walls. The honeycomb body is preferably additionally surrounded by a housing, the dimensions of which substantially correspond to the axial extent and cross-sectional shape of the honeycomb body.

The structure of the catalytic converter body according to the invention, with wall thicknesses of the passage walls which are reduced at least in the region of an end surface results, at the end surface of the catalytic converter body onto which the exhaust gas flows directly, in a reduced surface area for the accumulation of soot particles to act upon in this region. This reduced surface area is unlike that which would be provided if the average wall thicknesses were maintained even at the end surface of the catalytic converter body. This counteracts the above-described effect, according to which deposition of soot particles begins at the end surfaces of catalytic converter bodies. Rapid covering of the axial passages which extend through the catalytic converter body as a result of the formation of thick depositions of soot on the starting sections thereof is effectively prevented in this way. As a result, the catalytic action of the catalytic converter body is also retained in particular in the starting region. Particular measures for the elimination of soot deposits, for example burning off these deposits by additional heating of the starting sections of catalytic converter bodies according to the prior art, may even be avoided under certain circumstances as a result of the configuration according to the invention. That is because the catalytic reaction in the starting sections begins quickly and may ignite particles which have been deposited further downstream. This also eliminates the structural features which are required for additional heating of the starting sections.

In accordance with another feature of the invention, the respective starting sections of the passage walls, starting from the end surface, each have an extent in the axial direction which is from 1 to 10 mm, particularly preferably from 2 to 5 mm, long. The result is a sufficient reduction in the wall thickness in the region of at least one end surface of the catalytic converter body. In principle, it is only necessary to reduce the wall thickness on the inflow side, but for reasons of symmetry this reduction may take place at both end sides, in order to allow the catalytic converter body to be fitted in either direction.

In accordance with a further feature of the invention, since, overall, the wall thickness of the passage walls of the catalytic converter body is determined by the thickness of the walls of the honeycomb body and by the thickness of the coating, in structural terms it is particularly advantageous for the respective starting sections of the passage walls to be constructed in such a way that they are uncoated or substantially uncoated on at least one side. In this way, a reduced wall thickness according to the invention with the advantages which have been mentioned can be achieved in a particularly simple way.

In accordance with an added feature of the invention, the passage walls, in the region of the starting sections, are constructed to taper substantially to a point toward the end surface of the catalytic converter body, which is particularly advantageous. This results in a wall thickness which decreases continuously toward the end surface, so that the cross-sectional area onto which the exhaust gas effectively flows can be reduced particularly effectively in the region of the end surface of the catalytic converter body. In addition, in terms of flow, a configuration of this type is particularly favorable for reducing the levels of deposits. This is because, in the most favorable situation, the passage walls are reduced from their average wall thickness down to a sharp leading edge in the end-surface region of the catalytic converter body.

In accordance with an additional feature of the invention, the honeycomb body is formed substantially from intertwined sheet-metal layers, preferably from alternating layers of substantially smooth metal sheets and substantially corrugated metal sheets. In addition, the honeycomb body may preferably substantially be formed from ceramic material, in particular by extrusion, and at least one end side may have wall thicknesses which are reduced by reshaping.

With the objects of the invention in view, there is also provided a process for producing a catalytic converter body, which comprises forming at least one honeycomb body with an end surface and a multiplicity of axial passages through which a fluid can flow in a flow direction in a manner known per se. The at least one honeycomb body is substantially provided with a catalytically active coating. The passages are provided with respective passage walls delimited substantially in a common plane perpendicular to the flow direction. Each of the passage walls has an average wall thickness over the axial extent of the catalytic converter body and respective starting sections having reduced wall thicknesses as compared to the average wall thicknesses at least in the vicinity of the end surface. In addition, in customary applications for motor vehicles, the catalytic converter body will be sheathed by forming a housing to accommodate the honeycomb body.

According to the invention, in order to increase the effectiveness of the catalytic converter body, it is sufficient simply to form the starting sections of the respective passage walls with reduced wall thicknesses in the region of an end surface of the catalytic converter body. The result is a low structural outlay and therefore simple and inexpensive production of a catalytic converter body according to the invention which is constructed to counteract the accumulation of particles, in particular soot particles, in the region of an end surface.

In accordance with another mode of the invention, the honeycomb body is formed substantially from ceramic material. In particular, a honeycomb body of this type may be extruded and then reshaped on at least one end side.

In accordance with a further mode of the invention, the honeycomb body is formed substantially from stacked sheet-metal layers, preferably from alternating layers of substantially smooth metal sheets and substantially corrugated metal sheets, by intertwining these sheet-metal layers. In this case, it is particularly preferable for the width of the metal sheets to be cut according to a desired length in the axial direction of the honeycomb body, the cuts in question being made obliquely, with the result that in each case the starting sections have a pointed structure.

Therefore, both the cutting to the desired length of the honeycomb body and the formation of the starting sections of reduced wall thicknesses can take place in a single working step. Combining these two operations in one working step results in an embodiment of the process according to the invention which is particularly effective both in terms of time and cost.

In accordance with an added mode of the invention, the honeycomb body is initially produced in one of the ways described above and then coated, in particular by immersing the honeycomb body in a bath, without the starting sections being coated. Therefore, it is possible for both honeycomb bodies which are formed substantially from ceramic material and honeycomb bodies which are substantially intertwined from stacked sheet-metal layers to be both coated and formed with reduced wall thicknesses in the region of an end surface of the honeycomb body formed in this way in one working step.

In accordance with a concomitant mode of the invention, if the honeycomb body is substantially intertwined from stacked sheet-metal layers, the sheet-metal layers are initially coated, in particular by immersing them in a bath, and then intertwined to form the honeycomb body. According to the invention, in the coating step, those sections of the sheet-metal layers which correspond to the respective starting sections in the region of the end surface of the catalytic converter body formed in the intertwining step are not coated or substantially are not coated, or the coating is removed again. This process may in addition be combined with the embodiment of the process in which the respective starting sections of the honeycomb body are formed by obliquely made cuts on the metal sheets.

Other features which are considered as characteristic for the invention are set forth in the appended claims.

Although the invention is illustrated and described herein as embodied in a catalytic converter body with reduced wall thickness on an inflow side and a process for producing a catalytic converter body, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a diagrammatic, sectional, plan view of a preferred embodiment of a catalytic converter body according to the invention;

FIG. 2 is a sectional side view of a preferred embodiment of the catalytic converter body according to the invention;

FIG. 3A is an enlarged, fragmentary, sectional side view of starting sections of a first preferred embodiment according to the invention;

FIG. 3B is a fragmentary, sectional view taken along a line IIIB-IIIB of FIG. 3A, in the direction of the arrows;

FIG. 3C is a fragmentary, sectional view taken along a line IIIC-IIIC of FIG. 3A, in the direction of the arrows;

FIG. 4A is an enlarged, fragmentary, sectional side view of starting sections of a second preferred embodiment according to the invention; and

FIG. 4B is a fragmentary, sectional view taken along a line IVB-IVB of FIG. 4A, in the direction of the arrows.

### DESCRIPTION OF THE PREFERRED EMBODIMENTS

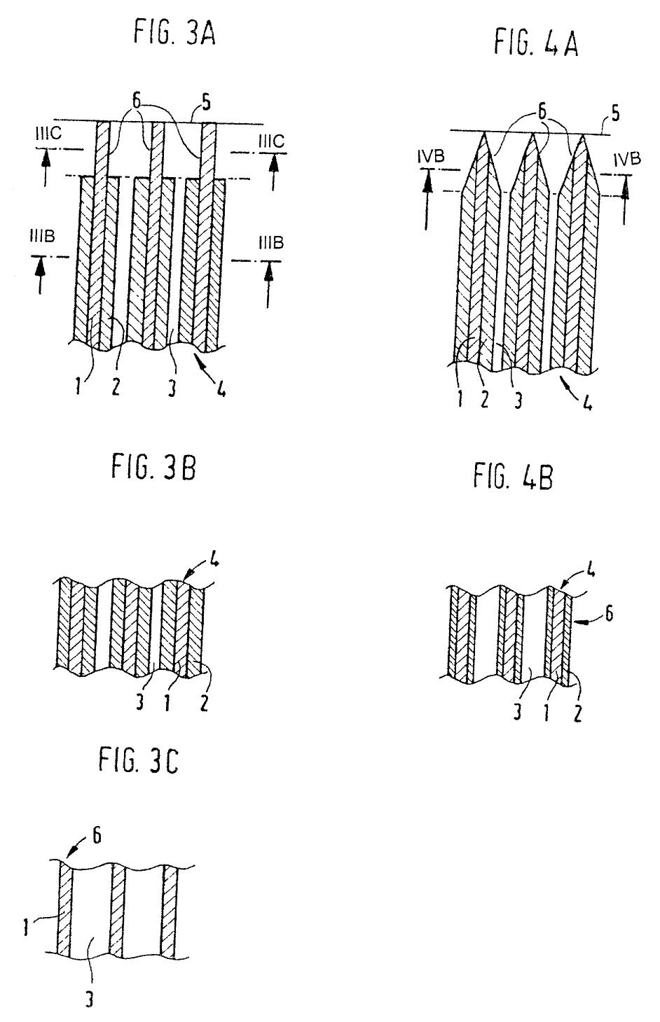

Referring now to the figures of the drawings in detail and first, particularly, to FIG. 1 thereof, there is seen a sectional plan view of a catalytic converter body according to a preferred embodiment of the invention. The catalytic converter body includes a honeycomb body 1 having sheet-metal layers which are intertwined in involute form. In this case, the catalytic converter body includes alternating layers of substantially smooth metal sheets and corrugated metal sheets, a coating 2 (shown in FIGS. 3A, 3B, 3C, 4A and 4B) of the honeycomb body 1, which contains a catalytically active material, and preferably a housing that surrounds the honeycomb body 1. In the honeycomb body 1, the intertwined metal sheets form respective passage walls 4 of a multiplicity of axial passages 3 through which a fluid can flow.

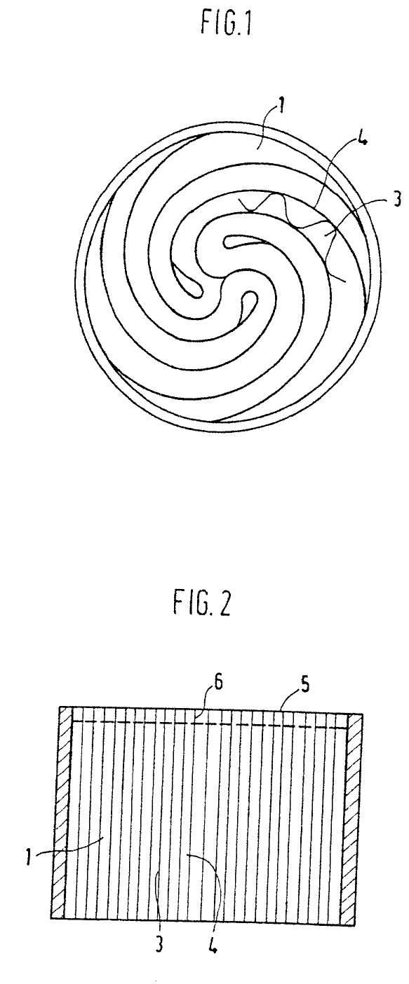

FIG. 2 shows a sectional side view of the catalytic converter body of FIG. 1. The intertwined metal sheets which form the honeycomb body 1 are disposed in a housing that is shown in section with hatching. The catalytic converter body 1 is constructed as a honeycomb body and includes a multiplicity of axial passages 3 through which a fluid can flow and the respective passage walls 4 of which each have substantially average wall thicknesses over their axial extent. According to the invention, in the region or vicinity of an end surface of the catalytic converter body, the respective passage walls 4 have starting sections 6 with reduced wall thicknesses. In each case, the starting sections 6 start from the end surface 5 and have an extent in the axial direction which is indicated by a dashed line in FIG. 2.

FIG. 3A shows an enlarged side view of the area of the end surface 5 of the catalytic converter body with the corresponding starting sections 6 of the respective passage walls 4 according to a first preferred embodiment of the invention. The axial passages 3 through which a fluid can flow are in each case formed between the individual passage walls 4. The passage walls 4 substantially have an average wall thickness over their axial longitudinal extent. This wall thickness results from the actual honeycomb body 1 and the coating 2, which is present in each case in FIG. 3 on both sides of the actual honeycomb body 1. This coating preferably is formed of a substantially porous wash coat of A1₂O₃, in which the catalytically active material is, for example, Pt and/or Rh. In this first preferred embodiment, the starting sections 6 according to the invention are formed by the passage walls 4 not having any coating 2 on these sections. In the case of the catalytic converter body shown in FIG. 3A, this applies to both sides of the honeycomb body 1. However, it is also conceivable for only one side in each case to remain uncoated in the region of the starting sections 6 or for only some of the respective starting sections 6 to remain uncoated.

The size relationships, in particular the ratios of the mean wall thicknesses of the respective passage walls 4 to the widths of the respective passages 3, are not to scale in FIG. 3A or the other figures.

FIG. 3B shows a plan view of a section taken along a line IIIB-IIIB in FIG. 3A. The figure shows a section of the passage walls 4 in the region of the honeycomb body in which the passage walls 4 are each provided with the coating 2 on both sides of the honeycomb body 1 and each have an average wall thickness.

By contrast, FIG. 3C shows a plan view of a section taken along a line IIIC-IIIC through the catalytic converter body shown in FIG. 3A. The section IIIC-IIIC runs in the region of the respective starting sections 6 of the respective passage walls 4. In contradistinction to the section shown in FIG. 3B, it can be seen from the section shown in FIG. 3C that the wall thickness in the region of the starting sections 6 is significantly less than the average wall thickness as illustrated in FIG. 3B. In the first preferred embodiment shown in accordance with FIGS. 3A, 3B and 3C, the reduced wall thickness of the passage walls 4 in the region of the end surface 5 is achieved by the fact that the starting sections 6 of the passage walls 4 do not have any coating 2. This can be seen in particular in the section IIIC-IIIC of FIG. 3C.

FIG. 4A shows an enlarged side view of the area of an end surface 5 of the catalytic converter body according to the invention with a second preferred embodiment of the starting sections 6 according to the invention, which have reduced wall thicknesses as compared to the average wall thicknesses of the passage walls 4. In this case too, the catalyst carrier body 1 is substantially constructed as a honeycomb body with a coating 2 which contains a catalytically active material and with a multiplicity of axial passages 3 through which a fluid can flow. With regard to the composition of the coating, the same statements as those which have already been made in connection with FIG. 3A apply.

In this second embodiment of the starting sections 6, the passage walls 4 are constructed to taper substantially to a point toward the end surface 5 in the region or vicinity of the starting sections. FIG. 4A shows a decreasing thickness of the coating 2 of the honeycomb body 1 looking upward from the lower part of the starting sections 6. In each case partial sections of the honeycomb body 1 taper to a point in the upper part above the coating that tapers to a point, as a result of the reduction in thickness. Naturally, it may also be possible, in this second embodiment, for the starting sections 6, in a similar manner to that shown in FIG. 3A, to remain substantially free of the coating 2 and for only the respective sections of the honeycomb body 1 to taper to a point.

FIG. 4B shows a plan view in section taken along a line IVB-IVB in FIG. 4A. The figure shows the reduced wall thickness of the respective passage walls 4 in the region of the respective starting sections 6, with reduced thicknesses of the coating 2 on both sides in each case. The result, therefore, in addition to the reduced wall thicknesses of the passage walls 4, in a similar manner to the first exemplary embodiment shown in FIGS. 3A, 3B and 3C (and as can be seen in particular from FIG. 3C), is also a widening of the axial passages 3 in the region of the respective starting sections 6. The widening also counteracts blocking of these passages 3 by soot deposits and therefore constitutes a further advantage of the catalytic converter body according to the invention.

We claim:

1. A catalytic converter body, comprising:
at least one honeycomb body having an end surface and a multiplicity of axial passages through which a fluid can flow in a flow direction, said passages having respective passage walls ending substantially in a common plane perpendicular to said flow direction, said passage walls each having substantially average wall thicknesses, and said passage walls each having starting sections with reduced wall thicknesses as compared to said average wall thicknesses at least in the vicinity of said end surface.

2. The catalytic converter body according to claim 1, wherein said at least one honeycomb body has a catalytically active coating.

3. The catalytic converter body according to claim 1, wherein said respective starting sections of said passage walls each have an extent in axial direction of from 1 to 10 mm long, starting from said end surface.

4. The catalytic converter body according to claim 1, wherein said respective starting sections of said passage walls each have an extent in axial direction of from 2 to 5 mm long, starting from said end surface.

5. The catalytic converter body according to claim 2, wherein said respective starting sections of said passage walls are substantially uncoated on at least one side of said passage walls.

6. The catalytic converter body according to claim 1, wherein said passage walls taper substantially to a point toward said end surface in the vicinity of said starting sections.

7. The catalytic converter body according to claim 1, wherein said at least one honeycomb body is formed substantially from intertwined sheet-metal layers.

8. The catalytic converter body according to claim 1, wherein said at least one honeycomb body is formed substantially from intertwined alternating layers of substantially smooth metal sheets and substantially corrugated metal sheets.

9. The catalytic converter body according to claim 1, wherein said at least one honeycomb body is formed from ceramic material.

10. The catalytic converter body according to claim 1, wherein said at least one honeycomb body is formed from extruded ceramic material.

11. A process for producing a catalytic converter body, which comprises:
forming at least one honeycomb body with an end surface and a multiplicity of axial passages through which a fluid can flow in a flow direction;
substantially providing the at least one honeycomb body with a catalytically active coating;
providing the passages with respective passage walls delimited substantially in a common plane perpendicular to the flow direction; and
providing each of the passage walls with an average wall thickness and with respective starting sections having reduced wall thicknesses as compared to the average wall thicknesses at least in the vicinity of the end surface.

12. The process according to claim 11, which further comprises forming the at least one honeycomb body substantially from ceramic material, and reshaping the at least one honeycomb body on at least one end side for reducing the wall thickness.

13. The process according to claim 11, which further comprises extruding the at least one honeycomb body substantially from ceramic material, and reshaping the at least one honeycomb body on at least one end side for reducing the wall thickness.

14. The process according to claim 11, which further comprises intertwining the at least one honeycomb body substantially from stacked sheet-metal layers.

15. The process according to claim 11, which further comprises intertwining the at least one honeycomb body substantially from stacked alternating layers of substantially smooth metal sheets and substantially corrugated metal sheets.

16. The process according to claim 14, which further comprises obliquely cutting a width of the metal sheets to a desired length in axial direction of the at least one honeycomb body, causing each of the starting sections to taper to a point.

17. The process according to claim 11, which further comprises initially producing the at least one honeycomb body and then coating the at least one honeycomb body except for the starting sections.

18. The process according to claim 11, which further comprises initially producing the at least one honeycomb body and then immersing the at least one honeycomb body, except for the starting sections, in a bath, for coating the at least one honeycomb body except for the starting sections.

19. The process according to claim 14, which further comprises initially providing all of the stacked sheet-metal layers with a coating, and then intertwining the stacked sheet-metal layers to form the at least one honeycomb body, while at least substantially not coating the starting sections.

20. The process according to claim 14, which further comprises initially providing all of the stacked sheet-metal layers with a coating by immersing the stacked sheet-metal layers in a bath, and then intertwining the stacked sheet-metal layers to form the at least one honeycomb body, while at least substantially not coating the starting sections.

21. The process according to claim 14, which further comprises initially providing all of the stacked sheet-metal layers with a coating, then intertwining the stacked sheet-metal layers to form the at least one honeycomb body, and then removing the coating from the starting sections.

22. The process according to claim 14, which further comprises initially providing all of the stacked sheet-metal layers with a coating by immersing the stacked sheet-metal layers in a bath, then intertwining the stacked sheet-metal layers to form the at least one honeycomb body, and then removing the coating from the starting sections.
